(19) United States
(12) Patent Application Publication
(10) Pub. No.: US 2009/0066959 A1
(43) Pub. Date: Mar. 12, 2009

(54) Apparatus and Method for Estimating a Property of a Fluid in a Wellbore Using Photonic Crystals

(75) Inventor: Rocco DiFoggio, Houston, TX (US)

Correspondence Address: MADAN, MOSSMAN & SRIRAM, P.C., 2603 AUGUSTA DRIVE, SUITE 700, HOUSTON, TX, 77057-5662, US

(73) Assignee: BAKER HUGHES INCORPORATED, Houston, TX (US)

(21) Appl. No.: 11/852,097

(22) Filed: Sep. 7, 2007

(51) Int. Cl. G01N 21/17; E21B 49/08

(52) U.S. Cl. 356/442; 73/152.04

(57) ABSTRACT

A method, system and an apparatus for estimating a property of a fluid in a wellbore are disclosed. In one aspect, the fluid may be exposed to light and light reflected by or passed through the fluid may be separated into a plurality of channels by a plurality of photonic crystals, each providing light corresponding to particular center wavelength. In another aspect, the light may be passed through a plurality of photonic crystals to provide light centered about one or more wavelengths. The fluid then may be exposed to the light output from the photonic crystals. Light detected from the fluid corresponding to each center wavelength is processed to estimate the parameter of interest.

### BACKGROUND OF THE DISCLOSURE

1. Field of the Disclosure

The disclosure herein relates generally to estimating a property of a fluid downhole.

2. Description of the Related Art

Oil wells (also referred to as “wellbores” or “boreholes”) are drilled into subsurface formations to produce hydrocarbons (oil and gas). A drilling fluid, also referred to as the “mud,” is circulated via a drill string during drilling of the wellbores. A majority of the wellbores are drilled with overpressured conditions, i.e., in a manner so that the fluid pressure gradient in the wellbore due to the weight of the mud is greater than the natural fluid pressure gradient of the formation in which the wellbore is being drilled. Because of the overpressure condition, the mud penetrates the formation surrounding the wellbore to varying depths, thereby contaminating the natural or connate fluid contained in the formation.

To estimate or determine the type of the fluid in a formation (such as oil, gas, water, etc.) at a particular wellbore depth or to estimate the condition of the reservoir surrounding the wellbore, tools referred to as the “formation testing” tools are employed both during drilling of the wellbores and after the wellbores have been drilled to obtain samples of the connate fluid for analysis. During drilling of the wellbore, such tools are deployed in a drilling assembly above the drill bit. After drilling the wellbore, such tools are conveyed into the wellbore via a wireline or a coiled-tubing. To obtain a sample of the connate fluid, a probe is often used to withdraw the fluid from the formation. The fluid from the formation is typically pumped into the well for a certain period of time (often as long as one hour or more) to ensure that the fluid being withdrawn is substantially free of the mud. Spectrometers have been used to estimate when the fluid being drawn is of an acceptable quality level, i.e., that the mud contamination level is acceptable. Such spectrometers typically use relatively high band pass optical filters to process relatively wide bands of light for each channel to obtain a spectrum of light. Such wide band pass filters in downhole spectrometers provide relatively low resolution spectrum of a desired property of interest, such as absorbance, refractive index. etc.

This disclosure provides improved methods, systems and apparatus for estimating properties of fluids downhole using photonic crystals.

### SUMMARY

In one aspect, a method for estimating a property of a fluid downhole may include: filtering light received from a light source by a plurality of photonic crystals to produce light output from each photonic crystal corresponding to a relatively narrow bandpass of light each at a different center wavelength; exposing the fluid downhole to light output corresponding to each center wavelength; detecting light from the fluid corresponding to light for each center wavelength to produce corresponding signals; and processing the signals to estimate the property of the fluid.

In another aspect, the method may include: exposing a fluid downhole to light; using a plurality of photonic crystals downhole to produce light corresponding to a plurality of center wavelengths; sequentially exposing the fluid to light output from the plurality of photonic crystals; producing signals corresponding to each center wavelength for light received from the fluid; and processing the signals to estimate the property of interest of the fluid.

In another aspect, an apparatus may include: a light source that emits light; a plurality of photonic crystals that receive light from the light source wherein each photonic crystal provides light output that corresponds to a particular center wavelength and bandwidth; a fluid that receives light output from each photonic crystal; a detector that detects light from the fluid corresponding to each center wavelength; and a processor that estimates a property of interest using signals corresponding to light detected from the plurality of photonic crystals.

Another embodiment of the apparatus may include: a light source that exposes the fluid to light; a plurality of photonic crystals that receive light from the fluid downhole, wherein each photonic crystal provides light output corresponding to a selected center wavelength having a particular bandpass; and a processor that processes signals corresponding to the light output of the photonic crystals to estimate a property of interest.

The methods and apparatus for estimating a property of interest using photonic crystals downhole have been described rather broadly. The summary is provided to acquaint the reader with the subject matter of the disclosure only and is not intended to be used to limit the scope of the claim in any manner. Also, an abstract is provided at the end of the disclosure to conform to certain procedural requirements of the patent office and is not intended to be used to limit the scope of the claims in any manner.

### BRIEF DESCRIPTION OF THE DRAWINGS

For detailed understanding of the disclosure, references should be made to the following detailed description of the methods, systems and apparatus for estimating a property of the fluid downhole using photonic crystals, taken in conjunction with the accompanying drawings, in which like elements have generally been given like numerals, wherein:

FIG. 1 is a schematic illustration of a well logging system that includes a tool made according to one embodiment of the disclosure, which logging tool is shown conveyed in a wellbore for estimating a property of the fluid obtained from a formation surrounding the wellbore;

FIG. 2 is a schematic illustration of an exemplary well logging tool that that utilizes a spectrometer made according to one embodiment of the disclosure, which tool may be placed at a selected location in the wellbore of the system of FIG. 1 for in-situ analysis of the fluid being withdrawn from the formation;

FIG. 3 is a schematic diagram of a portion of a spectrometer made according to one embodiment for use in a downhole tool, such as the tool shown in FIG. 2, for estimating a property of the formation fluid;

FIG. 4 is a schematic diagram of a portion of a spectrometer made according to another embodiment for use in a downhole tool, such as the tool shown in FIG. 2, for estimating a property of the formation fluid;

FIG. 5 shows an example of a spectrum of an optical property of the fluid that may be obtained using a method, apparatus or system made according to one aspect of the disclosure; and

FIG. 6 shows another example of a spectrum of an optical property of the fluid that may be obtained using a method, apparatus or system made according to one aspect of the disclosure; and

FIG. 7 shows another example of a spectrum of a property of the fluid that may be obtained using a method, apparatus or system made according to one aspect of the disclosure.

### DETAILED DESCRIPTION

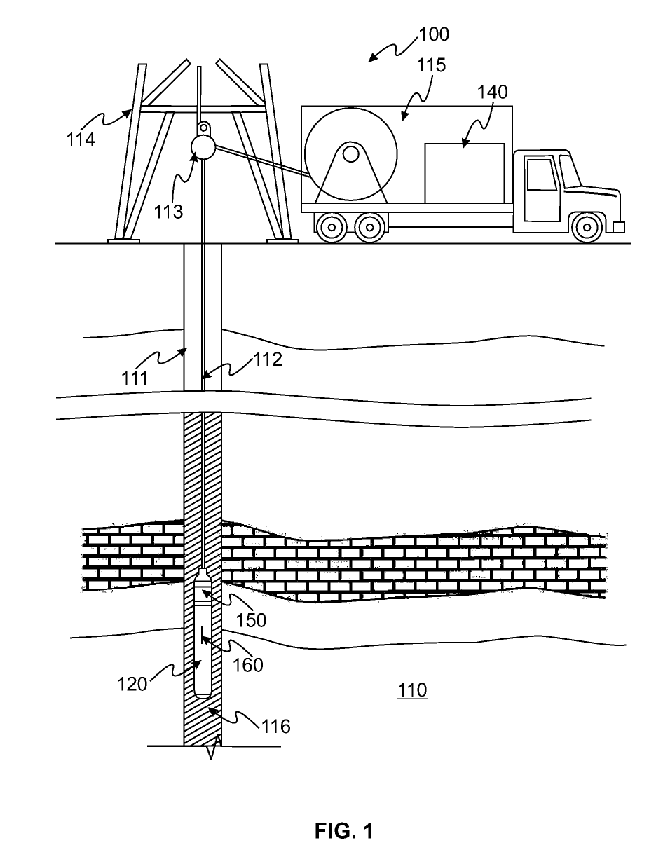

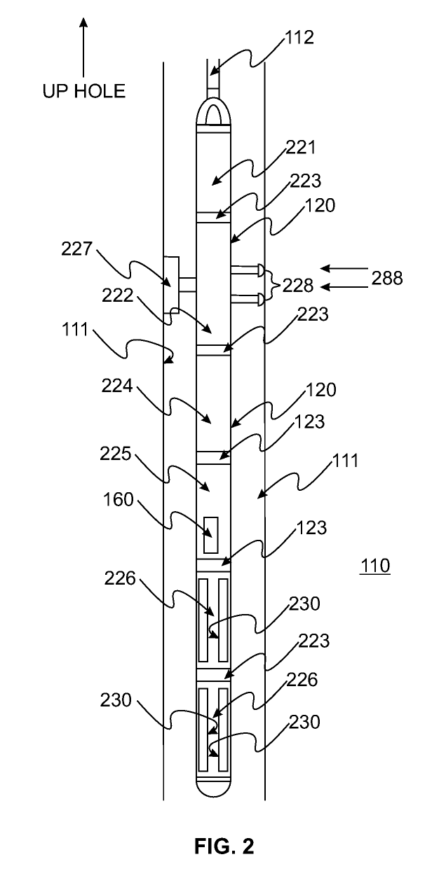

FIG. 1 is a schematic representation of a wireline formation testing system 100 for estimating a property of the formation fluid during the withdrawal of the fluid from the formation. The system 100 shows a wellbore 111 drilled in the formation 110. The wellbore 111 is shown filled with a drilling fluid 116, which is also is referred to as “mud” or “wellbore fluid.” The term “connate fluid” or “natural fluid” herein refers to the fluid that is naturally present in the formation, exclusive of any contamination by the fluids not naturally present in the formation, such as the drilling fluid. Conveyed into the wellbore 111 at the bottom end of a wireline 112 is a formation evaluation tool 120 that includes an analysis module 150, which module includes at least a portion of the spectrometer made according to one embodiment of the present disclosure for in-situ estimation of a property of the fluid withdrawn from the formation. Exemplary embodiments of the formation evaluation tools are described in more detail in reference to FIGS. 2-7. The wireline 112 typically is an armored cable that carries data and power conductors for providing power to the tool 120 and a two-way data communication link between the tool processor 150 and a surface control unit or controller 140 placed in logging unit, which may be a mobile unit, such as a logging truck 115 for land operations or may be an offshore platform or vessel (not shown) for underwater operations. The wireline 112 typically is carried from the surface unit 115 over a pulley 113 supported by a derrick 114. The controller 140, in one aspect, is a computer-based system, which may include: one or more processors such a microprocessor; one or more data storage devices, such as solid state memory devices, hard-drives, magnetic tapes, etc.; peripherals, such as data input devices and display devices; and other circuitry for controlling and processing data received from the tool 120. The surface controller 140 also includes or has access to one or more computer programs, algorithms, and computer models, which may be embedded in a computer-readable medium that is accessible to the processor in the controller 140 for executing instructions and information contained therein to perform one or more functions or methods associated with the operation of the 120.

FIG. 2 shows a schematic diagram of an embodiment of the formation evaluation or sampling tool 120 that includes a spectrometer that uses photonic crystals downhole for estimating a parameter of interest or characteristic of the fluid. The sampling tool 120 is shown to comprise several tool segments or modules that are joined end-to-end by threaded sleeves or mutual compression unions 223. The tool 120 includes a hydraulic power unit 221 and a formation fluid extractor 222. Below the extractor 222 a large displacement volume motor/pump unit 224 is provided for pumping fluid 288 from the formation 110 into the wellbore 111 and/or one or more sample tanks or chambers 230. Below the large volume pump 224 is shown a similar motor/pump unit 225 having a smaller fluid displacement volume, which fluid may be quantitatively monitored using the spectrometer 160. Ordinarily, one or more sample tank magazine sections 226 are assembled below the small volume pump 225. Each sample tank magazine section 226 may include one or more fluid sample tanks 30.

The formation fluid extractor 222 may comprise an extensible suction probe 227 that is opposed by bore wall feet 228. Both the suction probe 227 and the opposing feet 228 are extensible to firmly engage the wellbore walls, such as by the use of a hydraulic force application device, an electric motor, etc. Construction and operational details of fluid extraction tool 222 are described by U.S. Pat. No. 5,303,775, which is incorporated herein by reference.

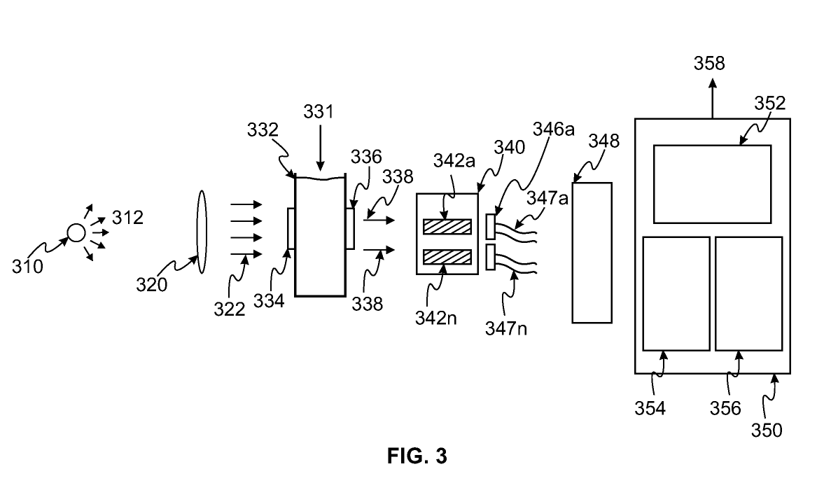

The tool 120 includes a spectrometer 160 for estimating a parameter of interest or characteristic of the fluid 188 withdrawn from the formation. The operations and function of the spectrometer 160 are described in more detail in reference to FIGS. 3-5. In operation, the probe 227 and the feet 228 are extended so that the probe sealingly presses against the borehole wall. The pump 224 may be used to pump the fluid from the formation into or through a chamber associated with the spectrometer 160 for in-situ analysis for estimating a property of the fluid. The clean fluid (i.e., fluid substantially free of mud contaminants) may be pumped into a sample collection tank, such as tank 226.

FIG. 3 shows a schematic diagram of a module 300 of the spectrometer for use in a downhole tool, such as the tool 120. It is shown to include certain elements or components of the spectrometer 160 made according to one exemplary embodiment. The spectrometer 160 may be utilized in a wireline tool, such as shown in FIGS. 1 and 2 or in a drilling assembly used for drilling a wellbore. A portion 332 of the formation fluid 188 is passed into or through a chamber 330. The chamber, in one aspect, may include a first window 334 for exposing the fluid in the chamber to light from a source 310 and a second window 336, generally on the opposite side of the first window, for allowing light to pass out of the fluid. The chamber 330 may hold the fluid or may allow it to pass therethrough. The light source 310, in one aspect, may be a white light source, such as a tungsten lamp, that emits a wide band of visible light (multi-color coherent light). Light emitted by the source is collimated by a suitable optical collimating device or collimator 320, such as a lens. Collimated light 322 impinges on the fluid 332 through the window 334. Light 338 passes out of the fluid 332 after interacting with the fluid 332. The interaction may include absorption and/or scattering of the light. A filter module 340 receives light 338 from the fluid and filters the light and provides output light corresponding to a number of different center wavelengths and full width half maximum (“FWHM”) bandpasses. The filter module 340, in one aspect, includes a number of photonic crystals, wherein each photonic crystal is tuned to provide light output corresponding to a distinct center wavelength and FWHM bandpass. Each photonic crystal may be designated to correspond to a channel in the tool. In one aspect, the light spectrum of interest may range from ultraviolet wavelength to infrared wavelength. The spectrum may be divided into a desired number of relatively narrow wavelength bands, each band having a particular center wavelength. Each such band may correspond to output light from a separate photonic crystal.

In one aspect, each photonic crystal may be fabricated to contain a specific pattern or a unique pattern of air spaces in a suitable semiconductor material such that each photonic crystal 342a-342n is tuned to provide output light that corresponds to a specific center wavelength and FWHW bandpass. In another aspect, the total number of photonic crystals may correspond to the total number of channels that comprise the desired spectrum. For example, if the spectrum of interest ranges from 200 nm to 2500 nm and the total desired channels equal fifty, then fifty photonic crystals may be tuned to cover the entire chosen spectrum. In one aspect, a number of photonic crystal channels may be packed into a relatively small space by using photonic crystal optical fibers. Such fibers, in one aspect, may contain many elongated air holes parallel to the fiber axis that run the length of the fiber. Such fibers are sometimes referred to as “holey fibers.” In another aspect, a group of photonic crystals may be tuned to different center wavelengths of interest. For example, a particular photonic crystal may be tuned to detect light transmitted through the fluid that corresponds to a particular wavelength band where the refractive index or absorption is of interest, such as for oil, water, gas, etc. In one aspect, each photonic crystal may be configured to contain a unique pattern of air spaces in a substrate (such as solid-state substrate) to provide output light corresponding to a particular center wavelength and FWHM bandpass. The photonic crystals may be housed in one or more common modules for use in the tool downhole. The modules, when desired, may be placed inside a cooling chamber, such as a flask or may be cooled using another cooling device, such as a sorption cooler or a cryogenic cooler.

Light from each photonic crystal may be detected by a common or separate detector. For example, photo detectors 246a-246n may be used to detect light from their corresponding photonic detectors 342a-342n. An interface circuit 348 receives light from the photo detectors 246a-246n, converts the received light into corresponding electrical signals, digitizes the electrical signals and provides the digitized signals to a controller 350. The controller 350 may include a processor 352, which may be a microprocessor, a set of computer programs, models and algorithms 354 stored in a data storage medium or memory 356 that is accessible to the processor 352. The processor processes the data received from the interface circuit to estimate a parameter of interest or characteristic of the fluid. The controller may be disposed in the downhole tool or at the surface. Alternatively, the data may be processed to a certain extent downhole by a first controller deployed in the tool and the remaining processing may be accomplished at the surface by another suitable controller, such as controller 140 (FIG. 1). Data communication between a downhole controller and the surface controller may be managed via any suitable telemetry link, such as link 358, including but not limited to a wireline, wired pipe, mud pulse telemetry, acoustic telemetry, electromagnetic telemetry, etc

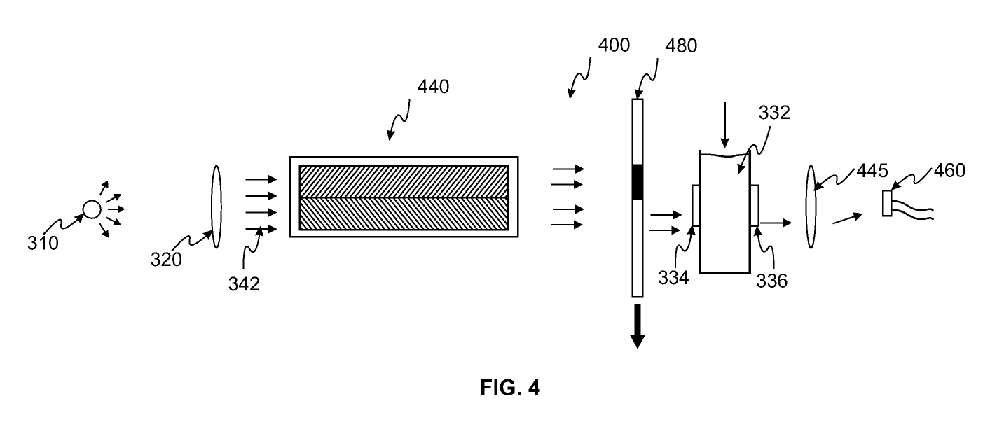

FIG. 4 is a schematic diagram of a portion of a spectrometer 400 made according to another embodiment for use in a downhole tool, such as tool 120 shown in FIG. 2, for estimating a property of the formation fluid. The spectrometer 400 includes a light source 310 and a collimator 320, such as described above. A photonic crystal module 440 is shown to contain a number of tuned photonic crystals 440a-440m, each of which receives the collimated light 342 and provides as output light 448 that corresponds to its respective center wavelength and FWHM bandpass. A filter 480, which may be a rotating wheel filter, sequentially filters light corresponding to the output band of each of the photonic crystals 442-442m. Light output 482 then passes through the fluid 332 and a collection lens 445 and is received by a photodetector 460, which converts the received light to electrical signals that pass to the interface 348 and controller 350 (FIG. 3) for processing in a manner described in reference to FIG. 3.

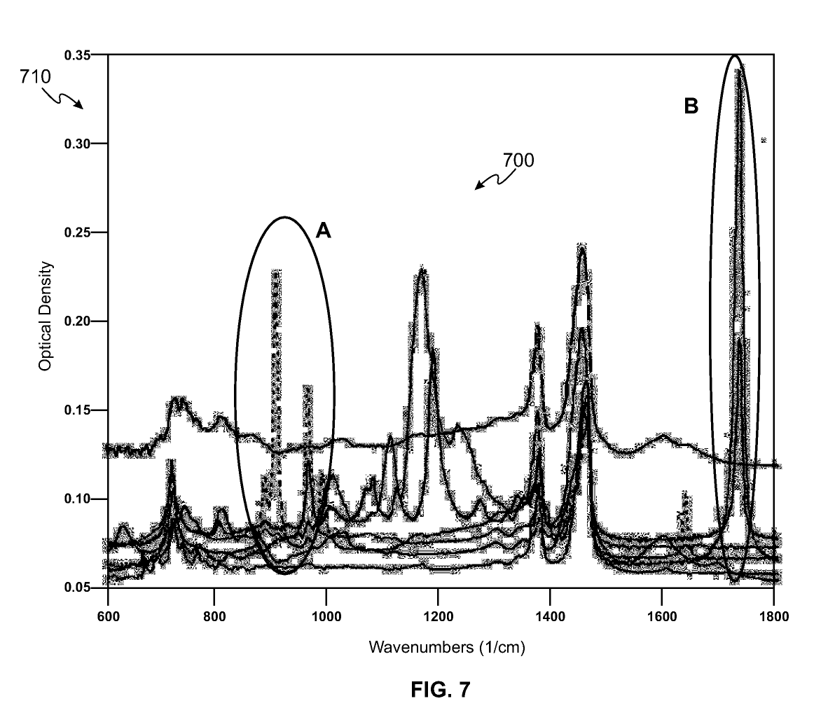

Referring back to FIG. 3, instead of using a broadband light source, a UV laser or another suitable light source may be used to induce or pump light into the fluid 322 through window 334. In some cases, it may be useful to pump laser light within a relatively narrow UV wavelength band or one tuned to produce a monochromatic (substantially single wavelength) UV light. The light 338 emitted by the fluid 332 is detected by the detector module 340, wherein the photonic crystals are tuned to detect a selected spectrum of light and provide such spectrum to the controller 350 for analysis. Alternatively, light reflected from the fluid may be detected for estimating a property of the fluid. Such a system may be utilized to obtain Raman scattering for estimating in-situ a parameter of interest of the fluid 322. An example of a Raman Spectrum is shown in FIG. 7

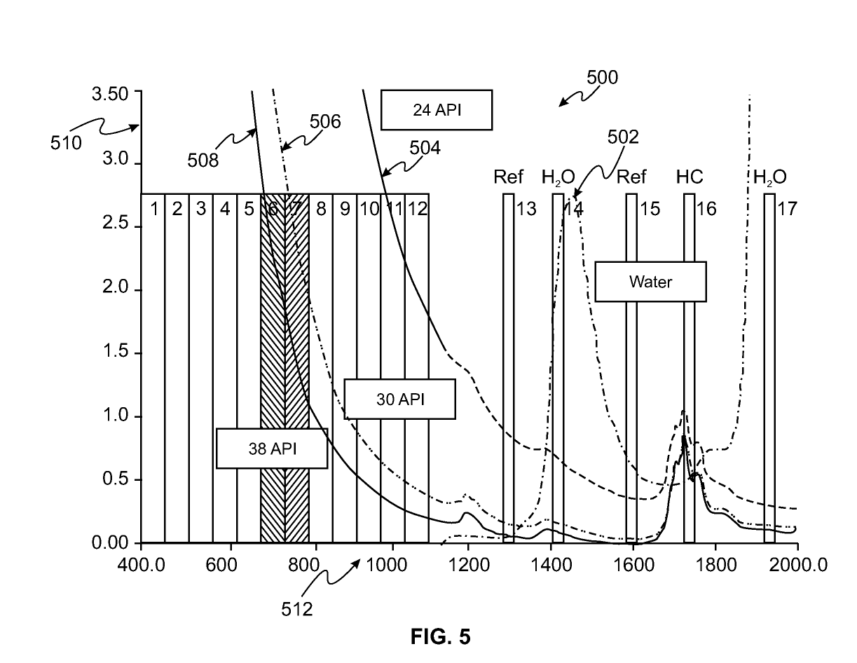

FIG. 5 shows an example of absorbance spectra 500 for water 502 and for three selected crude oil grades: 504 for 24 API, 506 for 30 API and 508 for 38 API that may be obtained using a method, system or apparatus made according to the disclosure herein. The absorbance spectra 500 is provided herein to illustrate certain aspects of the methods or processes used by the spectrometer made according to the disclosure herein, such as shown in FIGS. 3 and 4. The spectra 500 shows absorbance (in a log scale) along the vertical axis 510 and the wavelength of the detected light by the module 340 along the horizontal axis 512. The vertical bars (numbered 1-17) shown refer to channels corresponding to individual or particular photonic crystals, such as 342a-342n (FIG. 3). The channel size (wavelength band) and the number of channels used are for illustration purposes only. Each channel, however, typically may correspond to a narrow wavelength band. For example, absorbance for water has a peak of around 1452 nm while the various crude oil grades have absorbance peaks at 1725 nm and 1760 nm, which for example may be monitored by a single channel (such as channel 16) centered around 1740 nm. In this particular example, the spectrometer is shown configured to estimates or determines absorbance for oil at one or more wavelengths in the wavelength band 1725 nm to 1765 nm and for water around 1452 nm. The spectrometer also may be configured to estimate or determine the absorbance for solids at wavelengths around 1300 nm and/or 1600 nm where absorbance by the solids is substantially greater than the absorbance by either oil or gas. Thus, in one aspect, a spectrometer made according to the disclosure herein, such as spectrometer 300, may be configured to detect light at wavelengths where light is highly absorbed by a particular chemical or element of interest and minimally absorbed by another chemical or element of interest.

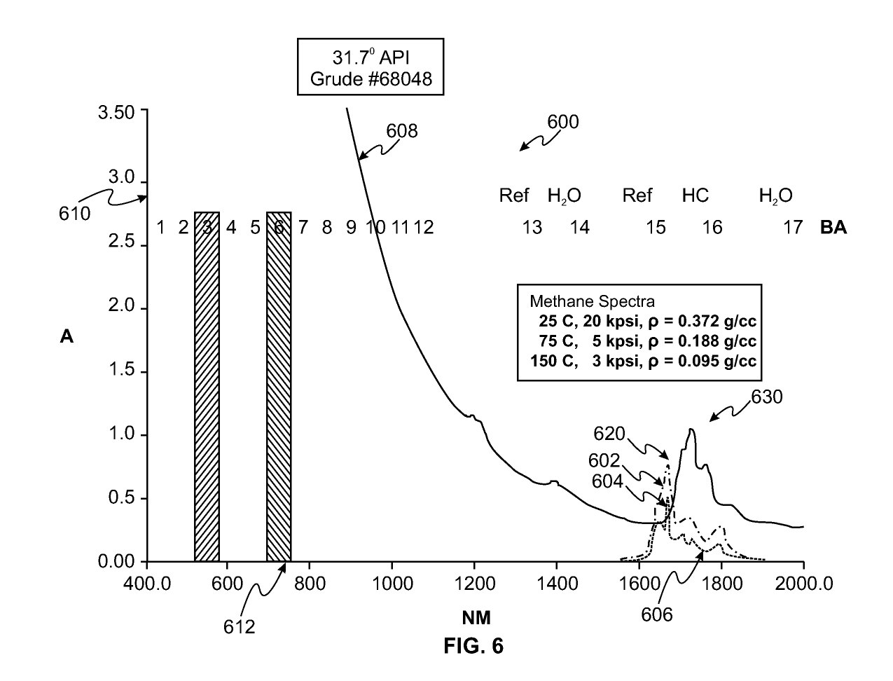

FIG. 6 depicts another example of a spectrum of a property of the fluid that may be obtained using a method, system or an apparatus made according to the disclosure. FIG. 6 shows absorbance spectra 600 for methane (gas) at various temperatures and pressures (602 at 25 degrees Celsius and 20K psi, 604 at 75 degrees Celsius and 5K psi and 606 at 150 degrees Celsius and 3K) and an absorbance spectrum 608 for a particular grade (31.7° API) of crude oil. The absorbance is shown along the vertical axis 610 and the wavelength is shown along the horizontal axis 612. FIG. 6 shows that absorbance peak 620 for natural gas, which is mostly methane, occurs around 1667 nm and the absorbance peak 630 for the particular oil occurs around 1740 nm. The absorbance for gas at around 1740 nm is lower than that of oil and therefore, at that wavelength, gas typically appears as a weakly absorbing hydrocarbon. A spectrometer or imager made according to one embodiment of the disclosure, such as spectrometer 400 (FIG. 4), may be tuned to detect gas peaks and compare them with the oil and water peaks to estimate the presence and amount of gas in the fluid.

FIG. 7 shows an example of Raman spectrum 700 that may be obtained using a method, system or an apparatus disclosed herein. The example spectrum 700 shown is based on ultraviolet light of 250 nm pumped into a fluid sample that includes oil-based mud. The spectrum 700 shows the optical density along the vertical axis 710 and the wavenumber (1/cm) along the horizontal axis 712. Olefins are often present in oil-based muds and appear around wavenumbers between 850 and 1000 as shown by the zone “A.” Esters also are often present in oil-based mud, which appear at wavenumbers above 1700 nm, as shown by the zone “B.” By monitoring the optical density in the zones “A” and “B,” estimates of the contamination level of the formation fluid due to oil-based muds may be made. Ethers (not shown) appear at wavenumbers between 1085 nm-1150 nm. In another aspect, Raman-sensitive water soluble tracer(s) may be introduced into a water-based mud during drilling of a wellbore and then utilized to distinguish natural water in the formation from water-based mud filtrate using a Raman spectrometer made according to the disclosure herein.

Thus, in one aspect, an apparatus for estimating a property of a fluid in a wellbore may include: a plurality of photonic crystals carried by the apparatus, wherein each photonic crystal is configured to receive light from a light source and provide light output corresponding to a different center wavelength; a chamber that is configured to house (contain or flow through) the fluid and to expose the fluid to light output from each photonic crystal; a detector that receives light from the fluid corresponding to each center wavelength and provides signals representative of the received light; and a processor that processes the signals to estimate the property of the fluid. In one aspect, each photonic crystal may include a plurality of air holes in a solid state substrate that are arranged or configured so that it provides light output corresponding to its selected or particular center wavelength. In another aspect, a suitable filter, such as a color wheel, may be used to sequentially allow the light output from the plurality of the photonic crystals to pass to the fluid in the chamber.

The light source may be any suitable broadband source, including, but not limited to, an incandescent lamp and a laser. The property of the fluid may be any desired property, including, but not limited to: absorbance; (ii) refractive index; (iii) mud filtrate contamination; (iv) gas-oil ratio; (v) oil-water ratio; (vi) gas-water ratio; (viii) an absorbance spectrum; and (viii) a Raman spectrum. Additionally, a preprocessor associated with a controller may be located in a downhole portion of the apparatus, at the surface, or partially in the apparatus downhole and partly at the surface.

In another aspect, any method of extracting fluid from the formation for testing may be utilized, including, but not limited to, using a pump to pump the formation fluid into or through the chamber. The fluid may be first pumped into the wellbore for a period and then a portion of the fluid may be discharged into the chamber.

In another aspect, a method for estimating a property of interest of a fluid downhole may include the features of: passing light through a plurality of photonic crystals downhole, each photonic crystal being tuned to provide light output corresponding to a selected center wavelength and bandpass; sequentially exposing the fluid to light output from the plurality of photonic crystals; detecting light from the fluid corresponding to each center wavelength and providing signals corresponding to the light for each center wavelength; and processing the received signals to estimate the property of the fluid. In one aspect, the property of interest may be any suitable property, including but not limited to: (i) absorbance; (ii) refractive index; (iii) mud filtrate contamination; (iv) gas-oil ratio; (v) oil-water ratio; (vi) gas-water ratio; (viii) an absorbance spectrum; and (viii) a Raman spectrum. In one aspect, sequentially exposing the fluid to light may be done by sequentially filtering the light output from the plurality of the photonic crystals before exposing the fluid to the filtered light. Further, detecting light from the fluid, in one aspect, may be done by detecting light that passes through the fluid or the light that is reflected by the fluid. The fluid may be extracted from a formation by any method and passed to a chamber and exposed to the light output from each of the photonic crystals through an optical window.

In another aspect, the method may include the features of: exposing a fluid to light downhole; receiving light from the fluid by a plurality of photonic crystals to produce light output from each photonic crystal corresponding to a particular center wavelength and bandpass; providing signals representative of the light produced by each photonic crystal corresponding to each particular center wavelength; and processing the signals representative of the light produced by each photonic crystal to estimate the property of interest of the fluid. The method may further include: detecting light output from each photonic crystal by a photodetector; and producing signals corresponding to the detected light. In any method or apparatus, the processing may be done: (i) in the wellbore; (ii) at the surface; or (iii) at least partially in the wellbore and the surface. In this method, the fluid used may be extracted from a formation into a chamber in the wellbore that includes at least one window that allows the fluid to be exposed to the light.

In another aspect, the apparatus configured for use in a wellbore may include: a light source that emits light; a chamber configured to receive the fluid extracted from a formation surrounding the wellbore and to expose the fluid to the light emitted by the light source; a plurality of photonic crystals, each photonic crystal configured to receive light downhole from the fluid and to provide light output corresponding to a particular center wavelength and bandpass; a detector that receives light output from each photonic crystal and provides signals corresponding to each center wavelength; and a processor that processes the signals from the detector for estimating a property of interest. The apparatus may further include a filter that sequentially filters light output from the plurality of photonic crystals and directs the sequentially filtered light toward the fluid. A collimating lens may be used to collimate light emitted by the light source. A detector may be used to receive light sequentially corresponding to each center wavelength or a plurality of detectors may be utilized to receive light from a plurality of photonic crystals. A processor processes the signals corresponding to the light to estimate the property of interest.

In another aspect, a system may include a member that conveys a tool downhole, which tool includes at least a plurality of photonic crystals for producing light corresponding to a plurality of center wavelengths of light each with a relatively narrow bandpass. In one aspect, the system may be configured to direct light from the photonic crystals to the fluid for detection after the light passes through the fluid or is reflected by the fluid for estimating a parameter of interest. In another aspect, the system may be configured to expose the fluid to a relatively broad band of light and the photonic crystals may provide light output based on the light received from the fluid. The conveying member may be a tubing or wireline. The processing of signals may be accomplished downhole, at the surface, at a remote location or at any combination of the above. The data communication between the surface and the downhole apparatus may be established using any suitable telemetry method, including but not limited to, wireline, mud pulse telemetry, electromagnetic telemetry; wired-pipe telemetry, acoustic telemetry, wired pipe or any combination of these and other techniques.

While the foregoing disclosure is directed to certain embodiments that may include certain specific elements, such embodiments and elements are shown as examples and various modifications thereto apparent to those skilled in the art may be made without departing from the concepts described and claimed herein. It is intended that all variations within the scope of the appended claims be embraced by the foregoing disclosure.

What is claimed is:

1. An apparatus for estimating a property of a fluid in a wellbore, comprising:
a plurality of photonic crystals carried by the apparatus, each photonic crystal configured to receive light from a light source and provide light output corresponding to a selected center wavelength and bandpass;
a chamber configured to house the fluid and to expose the fluid to light output from each photonic crystal;
a detector that receives light from the fluid corresponding to each center wavelength and provides signals representative of the received light; and
a processor that processes the signals to estimate the property of the fluid.

2. The apparatus of claim 1, wherein each photonic crystal includes a solid state substrate that contains a plurality of air holes configured to provide the light output corresponding to a selected bandpass.

3. The apparatus of claim 2 further comprising a filter that sequentially allows light output from the plurality of the photonic crystals to pass to the fluid in the chamber.

4. The apparatus of claim 1, wherein the light source is selected from a group consisting of: (i) an incandescent lamp; and (ii) a laser.

5. The apparatus of claim 1, wherein the property of the fluid is selected from a group consisting of: (i) absorbance; (ii) refractive index; (iii) mud filtrate contamination; (iv) gas-oil ratio; (v) oil-water ratio; (vi) gas-water ratio; (viii) an absorbance spectrum; and (viii) a Raman spectrum.

6. The apparatus of claim 1, wherein the processor is located at one of: (i) in a downhole portion of the apparatus; (ii) at the surface; and (iii) in part in a downhole portion of the apparatus and in part at the surface.

7. The apparatus of claim 1, wherein the fluid is a formation fluid and wherein the apparatus further comprises a pump that is configured to pump the formation fluid from a formation into the chamber.

8. A method of estimating a property of a fluid in a wellbore, comprising:
passing light through a plurality of photonic crystals in the wellbore, each photonic crystal being tuned to provide light output corresponding to a selected center wavelength and bandpass;
sequentially exposing the fluid to light output from the plurality of photonic crystals;
detecting light from the fluid corresponding to each bandpass and providing signals corresponding to the light for each center wavelength; and
processing the received signals to estimate the property of the fluid.

9. The method of claim 8, wherein the property of interest is selected from a group consisting of: (i) absorbance; (ii) refractive index; (iii) mud filtrate contamination; (iv) gas-oil ratio; (v) oil-water ratio; (vi) gas-water ratio; (viii) an absorbance spectrum; and (viii) a Raman spectrum.

10. The method of claim 8, wherein sequentially exposing the fluid comprises sequentially filtering the light output from the plurality of the photonic crystals before exposing the fluid to the filtered light.

11. The method of claim 8, wherein detecting light from the fluid comprises detecting light that passes through or light that is reflected by the fluid.

12. The method of claim 8 further comprising:
extracting the fluid from a formation into a chamber; and
exposing the fluid in the chamber through an optical window to the light output from each photonic crystals.

13. A method of estimating a property of a fluid downhole, comprising:
exposing a fluid to light downhole;
receiving light from the fluid by a plurality of photonic crystals to produce light output from each photonic crystal corresponding to a particular center wavelength and bandpass;
providing signals representative of the light produced by each photonic crystal corresponding to each particular center wavelength; and
processing the signals representative of the light produced by each photonic crystal to estimate the property of interest of the fluid.

14. The method of claim 13, wherein the property of the fluid is selected from a group consisting of: (i) absorbance; (ii) refractive index; (iii) mud filtrate contamination; (iv) gas-oil ratio; (v) oil-water ratio; (vi) gas-water ratio; (viii) absorbance spectrum; and (viii) Raman spectrum.

15. The method of claim 13, wherein providing signals comprises:
detecting light output from each photonic crystal by a photodetector; and
producing signals corresponding to the detected light.

16. The method of claim 13, wherein the light source is selected from a group consisting of: (i) an incandescent lamp; and (ii) a laser.

17. The method of claim 13, wherein processing signals comprises processing the signals by one of: (i) in the wellbore; (ii) at the surface; and (iii) at least partially in the wellbore.

18. The method of claim 13 further comprising extracting the fluid from a formation into a chamber in the wellbore that includes at least one window that allows the fluid to be exposed to the light.

19. An apparatus configured for use in a wellbore, comprising:
a light source that emits light;
a chamber configured to receive the fluid extracted from a formation surrounding the wellbore and to expose the fluid to the light emitted by the light source;
a plurality of photonic crystals, each photonic crystal configured to receive light downhole from the fluid and to provide light output corresponding to a particular center wavelength and bandpass having;
a detector that receives light output from each photonic crystal and provides signals corresponding to each center wavelength; and
a processor that processes the signals from the detector for estimating a property of interest.

20. The apparatus of claim 19, wherein each photonic crystal includes a unique configuration of air spaces in a substrate to produce the light output corresponding to its particular center wavelength.

21. The apparatus of claim 19 further comprising a filter that sequentially filters light output from the plurality of photonic crystals and directs the sequentially filtered light toward the fluid.

22. The apparatus of claim 21 further comprising a collimating lens that collimates light emitted by the light source.

23. The apparatus of claim 21, wherein the detector receives the light sequentially corresponding to each center wavelength and the processor uses the light from the detector to estimate the property of interest.

24. The apparatus of claim 15, wherein the property of interest is selected from a group consisting of: (i) absorbance; (ii) refractive index; (iii) mud filtrate contamination; (iv) gas-oil ratio; (v) oil-water ratio; (vi) gas-water ratio; (viii) an absorbance spectrum; and (viii) a Raman spectrum.
